(19) United States
(12) Patent Application Publication
(10) Pub. No.: US 2017/0229271 A1
(43) Pub. Date: Aug. 10, 2017

(54) CIRCUIT BREAKER WITH QUICK RESPONSE AND SEPARATION AND QUICK RESPONSE AND SEPARATION METHOD FOR CIRCUIT BREAKER

(71) Applicant: Technology Power International Limited, Kwai Chung, Kowloon (HK)

(72) Inventors: ManFuk To, Kwai Chung, Kowloon (HK); Kenny Ho, Kwai Chung, Kowloon (HK)

(73) Assignee: Technology Power International Limited, Kwai Chung, Kowloon (HK)

(21) Appl. No.: 15/313,911

(22) PCT Filed: May 15, 2015
(86) PCT No.: PCT/CN2015/079053

§ 371 Date: Apr. 28, 2017

(30) Foreign Application Priority Data
May 27, 2014 (CN) 201410228910.5

(51) Int. Cl. H01H 71/10; H01H 71/24; H01H 71/12

(52) U.S. Cl. CPC H01H 71/10; H01H 71/128; H01H 71/24; H01H 2235/01

(57) ABSTRACT

A circuit breaker with quick response and separation and a quick response and separation method for the circuit breaker. The circuit breaker comprises a breaking contact group and a joint contact group. The breaking contact group comprises a movable breaking contact. The joint contact group comprises a movable joint contact. A movable contact limiting device used for limiting moving positions of the breaking contact and/or the joint contact is arranged between the breaking contact group and the joint contact group. The quick response and separation method for the circuit breaker comprises a breaking and opening step, wherein the breaking contact moves in a reverse direction and is separated independently ahead of the joint contact, or the breaking contact and the joint contact both move in a reverse direction and are separated at the same time.

### FIELD OF THE INVENTION

The present invention relates to power control equipment and in particular to a circuit breaker and a quick response and separation method for the same.

### BACKGROUND OF THE INVENTION

A circuit breaker is a switch device which can close, load and break the current in a normal circuit, and close, load within a scheduled time and break the current in an abnormal circuit.

At present, various circuit breakers have been widely applied in real life. In the conventional art, a circuit breaker generally includes a fixed contact at a fixed position and a movable joint contact, wherein the joint contact is moved to break the circuit connection in an abnormal circuit. In the prior art, circuit breakers have the following deficiencies.

(1) The separation speed is slow. When the circuit needs to be broken, the speed of separating the fixed contact from the joint contact is slow since only one movable joint contact is moved. Particularly, as the contact with some joint contacts needs to be reinforced by a compression spring, the compression spring needs to be extended first when a breaking and separation operation is performed, so that the separation speed of the contacts is further reduced, and it is likely to generate electric arcs. Consequently, the contacts are damaged, and the service life of the circuit breaker is shortened.

(2) The breaking control is not flexible, and a breaking operation cannot be performed at any time. When a circuit needs to be broken, only the joint contact can be moved during breaking since only one movable joint contact is moved. Particularly, when the joint contact is being closed or has just been closed, the breaking operation cannot be performed at any time, and there is a potential safety hazard.

(3) The structure is complicated. In the prior art, in order to eliminate the electric arc phenomenon, various arc extinction apparatuses or devices usually need to be additionally provided, so the structure design is complicated and the cost of the circuit breaker increases.

### SUMMARY OF THE INVENTION

To solve the above technical problems, one objective of the present invention is to provide a circuit breaker which realizes quick opening, flexible and any-time breaking, and simple structure.

To solve the above technical problems, another objective of the present invention is to provide a quick response and separation method for the circuit breaker which realizes quick opening, flexible and any-time breaking, and simple structure.

The present invention employs the following technical solutions.

A circuit breaker with quick response and separation is provided, the circuit breaker comprising a breaking contact group and a joint contact group, wherein: the breaking contact group includes a movable breaking contact; the joint contact group includes a movable joint contact; a movable contact limiting device used for limiting moving positions of the breaking contact and/or the joint contact is arranged between the breaking contact group and the joint contact group; and, once a breaking operation is triggered, the breaking contact moves in a reverse direction prior to the joint contact to separate from the joint contact, or the breaking contact and the joint contact both move in a reverse direction to separate from each other at the same time.

Preferably, the breaking contact group further includes a breaking contact lock catch for fixing the position of the breaking contact and a breaking separation spring for providing a separation tension for the breaking contact, one end of the breaking separation spring being fixed with the other end thereof being connected to the breaking contact; the joint contact group further includes a joint contact lock catch for fixing the position of the joint contact and a joint contact separation spring for providing a separation tension for the joint contact, one end of the joint contact separation spring being fixed while the other end thereof is connected to the joint contact; and, when a breaking operation is triggered, the breaking contact lock catch and the joint contact lock catch are released, respectively, so that the breaking contact and the joint contact are separated by the tension of the breaking separation spring and the tension of the joint contact separation spring, respectively.

In the first preferred implementation of the present invention, the extension and contraction of the breaking separation spring and the extension and contraction of the joint contact spring drive the breaking contact and the joint contact to move in a same straight line direction, respectively.

Preferably, the joint contact group further includes a joint contact thrust plate and a contact compression spring, and the joint contact is connected to one end of the joint contact separation spring successively through the contact compression spring and the joint contact thrust plate.

In the second preferred implementation of the present invention, the breaking contact group further includes a breaking pivoted shaft and a breaking pivoted arm, and the breaking separation spring drives the breaking contact to swing around the breaking pivoted shaft through the breaking pivoted arm; and, the joint contact group further includes a joint pivoted shaft and a joint pivoted arm, and the joint contact separation spring drives the joint contact to swing around the joint pivoted shaft through the joint pivoted arm.

Preferably, the joint contact group further includes a joint contact thrust plate and a contact compression spring, and the joint contact is connected to one end of the joint contact separation spring successively through the contact compression spring, the joint contact thrust plate and the joint pivoted arm.

In the third preferred implementation of the present invention, the circuit breaker further includes a central pivoted shaft; the breaking contact group further includes a breaking pivoted arm, and the breaking separation spring drives the breaking contact to swing around the central pivoted shaft through the breaking pivoted arm; and, the joint contact group further includes a joint pivoted arm, and the joint contact separation spring drives the joint contact to swing around the central pivoted shaft through the joint pivoted arm.

Preferably, the joint contact group further includes a contact compression spring, and the joint contact is connected to one end of the joint contact separation spring through the contact compression spring and the joint pivoted arm.

Preferably, the circuit breaker further includes one or more insulating plates; and, when the breaking contact is separated from the joint contact, the insulating plates are inserted between the breaking contact and the joint contact, and the insulating plates are connected to an insulating plate spring for providing to the insulating plates a driving force for insertion.

A quick response and separation method for a circuit breaker is provided, the method including a breaking and opening step, wherein: the breaking contact alone moves in a reverse direction prior to the joint contact and is separated from the joint contact, or the breaking contact and the joint contact both move in a reverse direction at the same time and are separated from each other.

Preferably, the quick response and separation method for a circuit breaker further includes a closing step, wherein: the breaking contact moves toward the joint contact and arrives at a contact position prior to the joint contact, and the joint contact moves toward the breaking contact, arrives at the contact position posterior to the breaking contact, and comes into contact with the breaking contact.

Preferably, the quick response and separation method for a circuit breaker further includes an opening step during the closing process, wherein: when the joint contact comes into contact with the breaking contact, and if the circuit needs to be broken immediately, the breaking contact is quickly separated from the joint contact in an opposite direction immediately.

The present invention has the following beneficial effects that:

In the circuit breaker with quick response and separation provided by the present invention, the breaking contact is adopted to replace a fixed contact in the conventional art; when the circuit breaker needs to carry out an opening and breaking operation, quick separation between the contacts is realized due to a two-way separation action between the breaking contact and the joint contact, so that the electric arc phenomenon is avoided or reduced, and the service life of the circuit breaker is prolonged; further, as the breaking contact can move independently of the joint contact, the circuit can be broken at any time, so that the circuit breaker is safer; moreover, the present invention has a simple structure, a low production cost and good economic and social effects.

In addition, in the present invention, an insulating plate structure is additionally arranged between the breaking contact and the joint contact, so better insulating and arc extinction effects are realized while quickening the opening speed of the circuit breaker. The technical problem of insufficient contact pressure is solved by arranging contact compression springs. Meanwhile, different switch structures are provided by a pivoted shaft, so that the design of the switch is diversified.

The present invention also has the following beneficial effects that: In the quick response and separation method for a circuit breaker provided by the present invention, the breaking contact alone moves in a reverse direction prior to the joint contact and is separated from the joint contact, or the breaking contact and the joint contact both move in a reverse direction at the same time and are separated from each other, so quick separation between the contacts is realized, so that the electric arc phenomenon is avoided or reduced, and the service life of the circuit breaker is prolonged; further, as the breaking contact can move independently of the joint contact, the circuit can be broken at any time, so that the circuit breaker is safer.

The present invention can be widely applied to various circuit breakers.

### BRIEF DESCRIPTION OF THE DRAWINGS

Specific implementations of the present invention will be further described below with reference to the accompanying drawings, wherein:

FIG. 1 is a structural diagram of a first embodiment according to the present invention;

FIG. 2 is a structural diagram of a second embodiment according to the present invention;

FIG. 3 is a structural diagram of a closed state of a third embodiment according to the present invention;

FIG. 4 is a structural diagram of a closed state of a fourth embodiment according to the present invention

FIG. 5 is a structural diagram of a fifth embodiment according to the present invention;

FIG. 6 is a flowchart of working steps of the first embodiment according to the present invention;

FIG. 7 is a flowchart of working steps of the second embodiment according to the present invention;

FIG. 8 is a structural diagram of an opened state of the third embodiment according to the present invention;

FIG. 9 is a structural diagram of an opened state of the fourth embodiment according to the present invention; and

FIG. 10 is a flowchart of working steps of the fifth embodiment according to the present invention.

### DETAILED DESCRIPTION OF THE EMBODIMENTS

It is to be noted that the embodiments of the present application and the features in the embodiments can be combined with each other without conflict.

FIGS. 1 to 5 show a circuit breaker with quick response and separation, including a breaking contact group 10 and a joint contact group 20. The breaking contact group 10 includes a breaking contact 11, a breaking contact lock catch 12 for fixing the position of the breaking contact 11, and a breaking separation spring 13 for providing a separation tension for the breaking contact 11. One end of the breaking separation spring 13 is fixed, while the other end thereof is connected to the breaking contact 11. The joint contact group 20 includes a joint contact 21, a joint contact lock catch 22 for fixing the position of the joint contact 21, and a joint contact separation spring 23 for providing a separation tension for the joint contact 21. One end of the joint contact separation spring 23 is fixed, while the other end thereof is connected to the joint contact 21. When a breaking operation is triggered, the breaking contact lock catch 12 and the joint contact lock catch 22 are released, respectively, so that the breaking contact 11 and the joint contact 21 are separated by the tensions of the breaking separation spring 13 and the joint contact separation spring 23, respectively. Preferably, when a breaking operation is triggered, the breaking contact 11 moves in a reverse direction prior to the joint contact 21 and is separated from the joint contact 21, or the breaking contact 11 and the joint contact 21 both move in a reverse direction at the same time and are separated from each other. Preferably, a movable contact limiting device used for limiting moving positions of the breaking contact and/or the joint contact 21 is arranged between the breaking contact group 10 and the joint contact group 20.

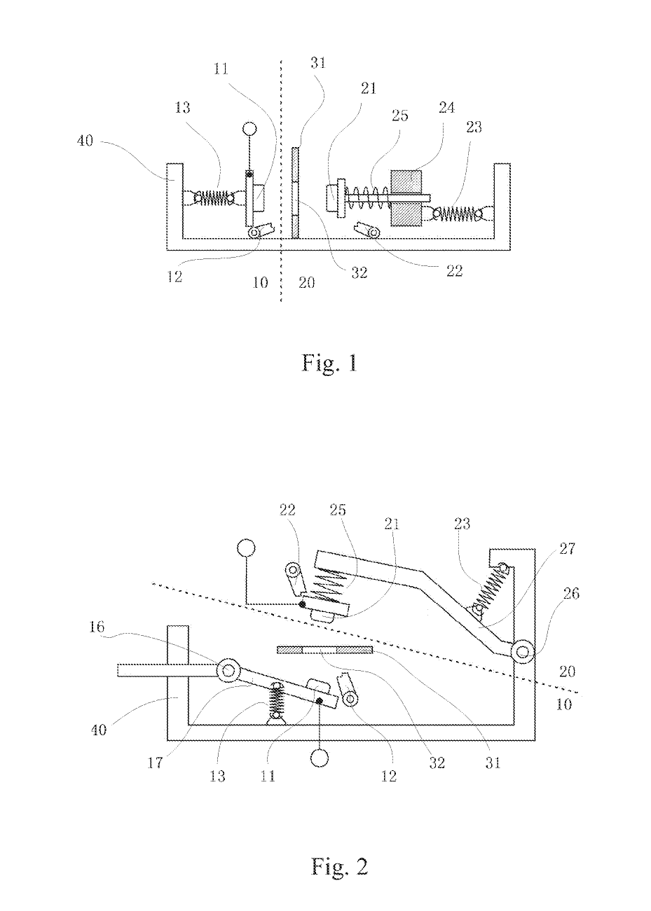

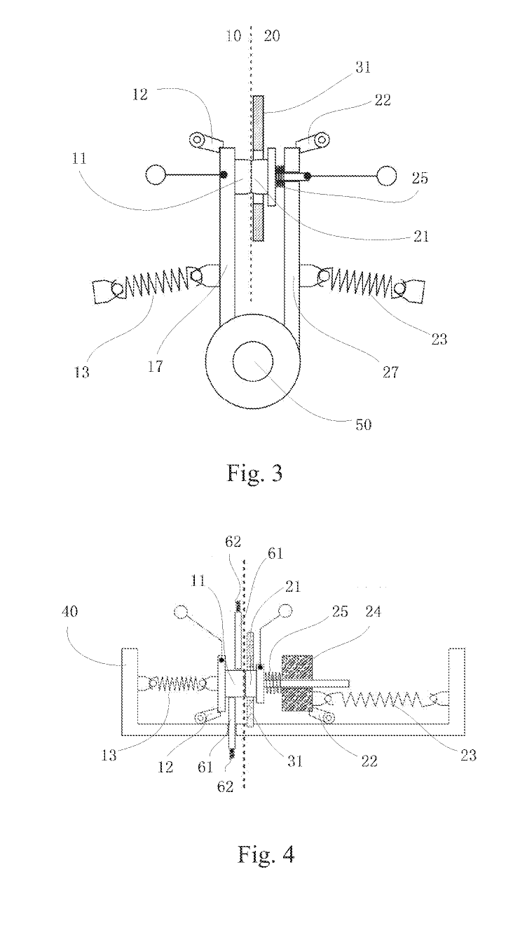

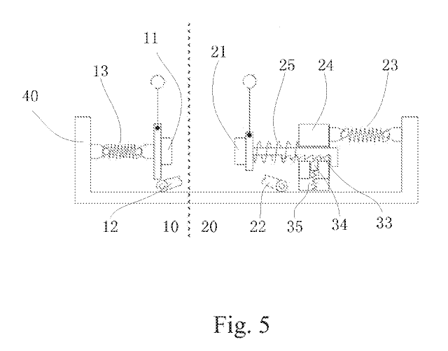

The contact limiting device can be a contact baffle 31 (for example, the first embodiment—FIG. 1, the second embodiment—FIG. 2, the third embodiment—FIG. 3 and the fourth embodiment—FIG. 4 of the present invention), or can also be a toothed lock catch structure (for example, the fifth embodiment of the present invention—FIG. 5).

The present invention further provides a quick response and separation method for a circuit breaker, including a breaking and opening step: the breaking contact alone moves in a reverse direction prior to the joint contact and is separated from the joint contact, or the breaking contact and the joint contact both move in a reverse direction at the same time and are separated from each other.

Preferably, the quick response and separation method for a circuit breaker further includes a closing step: the breaking contact moves toward the joint contact and arrives at a contact position prior to the joint contact, and the joint contact moves toward the breaking contact, arrives at the contact position posterior to the breaking contact, and comes into contact with the breaking contact.

Preferably, the quick response and separation method for a circuit breaker further includes an opening step in the closing process: when the joint contact comes into contact with the breaking contact, and if the circuit needs to be broken immediately, the breaking contact is quickly separated from the joint contact in an opposite direction immediately.

Closing action process: when the circuit breaker is closed, the breaking contact 11 is pushed by a driving force to move forward to the joint contact 21, and then the breaking separation spring 13 is stretched so that the breaking contact 11 is locked and stopped by the breaking contact lock catch 12. Then, the joint contact group 20 is pushed by a driving force to move toward the breaking contact group 10, so that the joint contact 21 comes into contact with the breaking contact 11. Subsequently, the joint contact group 20 continues to move toward the breaking contact group 10, so that a contact pressure between the breaking contact 11 and the joint contact 21 is increased, until the joint contact thrust plate 24 is locked and stopped by the joint contact lock catch 22. Thus, the closing process is accomplished.

Opening process after the closing process: the breaking contact lock catch 12 and the joint contact lock catch 22 are simultaneously or successively triggered to be released by a driving force, so the breaking operation begins to be performed. The breaking separation spring 13 is constricted to pull the breaking contact 11, so that the breaking contact 11 is immediately separated from the joint contact 21, and the quick breaking of the circuit is realized.

Opening process in the closing process: when the joint contact 21 is in contact with the breaking contact 11, the breaking contact lock catch 12 can be triggered to be released by a driving force at any time if there is a large current in the circuit, so that the breaking action is activated. Whatever state the joint contact 20 is in (resting or moving) at that moment, the circuit can be quickly broken, so that the any time circuit breaking is realized, the breaking control is more flexible and the circuit breaker is safer and more reliable.

It is to be noted that the driving force described above can be a manual or mechanical driving force or an electromagnetic force triggered by an electric signal.

As shown in FIG. 1, in the first embodiment of the present invention, the circuit breaker has a pedestal 40; both the breaking contact lock catch 12 and the joint contact lock catch 22 are arranged on the pedestal 40; one end of the breaking separation spring 13 is fixed on the pedestal 40, while the other end thereof is connected to the breaking contact; and, the extension and contraction of the breaking separation spring 13 and the extension and contraction of the joint contact spring drives the breaking contact 11 and the joint contact 21 to move in a same straight line direction, respectively. The joint contact group 20 further includes a joint contact thrust plate 24 and a contact compression spring 25, and the joint contact 21 is connected to one end of the joint contact separation spring 23 successively through the contact compression spring 25 and the joint contact thrust plate 24. The movable contact limiting device is a contact baffle 31, and a through hole 32 for allowing the breaking contact 11 and the joint contact 21 to pass therethrough and come into contact with each other is provided in the middle of the contact baffle 31.

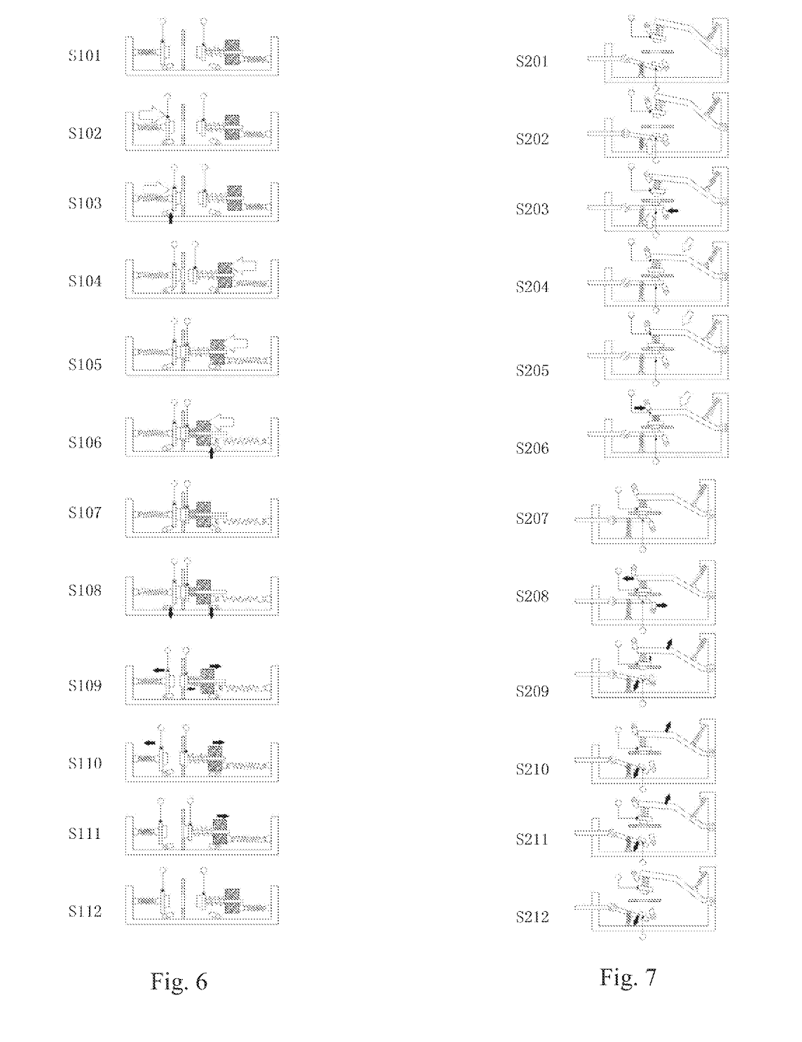

The closing process and the breaking and opening process of the first embodiment of the present invention will be described below in details with reference to FIG. 6.

Closing Process:

S101: The breaking contact 11 is separated from the joint contact 21, both the breaking contact lock catch 12 and the joint contact lock catch 22 are in a released state, and the breaking separation spring 13, the joint contact separation spring 23 and the contact compression spring 25 are all in a normal state.

S102: The breaking contact 11 moves toward the joint contact 21, and the breaking separation spring 13 is extended.

S103: The breaking contact 11 continues to move until being locked by the breaking contact lock catch 12.

S104: The joint contact thrust plate 24 of the joint contact group 20 is pushed to compress the contact compression spring 25, so that the joint contact 21 moves toward the breaking contact 11 and the joint contact separation spring 23 is stressed and extended.

S105: The joint contact thrust plate 24 is continuously pushed, so that the joint contact 21 comes into contact with the breaking contact 11.

S106: The joint contact thrust plate 24 is continuously pushed, and the contact compression spring 25 is stressed and compressed, so that the contact of the joint contact 21 with the breaking contact 11 is pressurized until the joint contact thrust plate 24 is locked by the lock catch. Thus, the closing process is finished.

It is to be noted that, steps S101 to S103 belong to an action process when the breaking joint group 10 is closed, and steps S104 to S106 belong to an action process when the joint contact group 20 is closed. The two groups of action processes do not influence each other, can be performed successively or simultaneously, or performed in reverse order.

Opening Process:

S107: The joint contact 21 is in contact with the breaking contact 11; the breaking contact 11 is locked by the breaking contact lock catch 12; the joint contact 21 is located by the joint contact lock catch 22 through the joint contact thrust plate 24; both the breaking separation spring 13 and the joint contact separation spring 23 are in an extended state; and the contact compression spring 25 is in a compressed state.

S108: The breaking contact lock catch 12 and the joint contact lock catch 22 are released, respectively (it is to be noted that the breaking contact lock catch 12 and the joint contact lock catch 22 can be released simultaneously or successively. In this embodiment, the description is illustrated only by taking simultaneously releasing the breaking contact lock catch and the joint contact lock catch as example. Successively releasing the breaking contact lock catch and the joint contact lock catch is similar to this embodiment and will be not repeated here).

S109: The breaking contact 11 is immediately moved backward and separated from the joint contact 21 by the tension of the breaking separation spring 13; the joint contact thrust plate 24 is moved backward by the tension of the joint contact separation spring 23, and the joint contact 21 is pressed toward the contact baffle 31 by the pressure of the compression spring 25; and the contact baffle 31 stops the joint contact 21 moving toward the breaking contact 11.

S110: The breaking contact 11 is continuously pulled by the breaking separation spring 13 so as to be separated from the joint contact 21, and the joint contact thrust plate 24 is continuously pulled to move backward by the joint contact separation spring 23.

S111: The joint contact thrust plate 24 is continuously pulled by the joint contact separation spring 23, so that the joint contact 21 is continuously away from the breaking contact 11.

S112: The breaking process is finished. The breaking contact 11 is separated from the joint contact 21, both the breaking contact lock catch 12 and the joint contact lock catch 22 are in a released state, and the breaking separation spring 13, the joint contact separation spring 23 and the contact compression spring 25 are all in a normal state.

As shown in FIG. 2, in the second embodiment of the present invention, the breaking joint group 10 further includes a breaking pivoted shaft 16 and a breaking pivoted arm 17, and the breaking separation spring 13 drives the breaking contact 11 to swing around the breaking pivoted shaft 16 through the breaking pivoted arm 17. The joint contact group 20 further includes a joint pivoted shaft 26 and a joint pivoted arm 27, and the joint contact separation spring 23 drives the joint contact 21 to swing around the joint pivoted shaft 26 through the joint pivoted arm 27. Preferably, the joint contact group 20 further includes a joint contact thrust plate 24 and a contact compression spring 25, and the joint contact 21 is connected to one end of the joint contact separation spring 23 successively through the contact compression spring 25, the joint contact thrust plate 24 and the joint pivoted arm 24.

As shown in FIG. 7, the working process S201 to S212 of the second embodiment of the present invention corresponds to the working process S101 to S112 of the first embodiment of the present invention. Except for the differences that the breaking pivoted shaft 16, the breaking pivoted arm 17, the joint pivoted shaft 26 and the joint pivoted arm 27 are arranged on the pedestal 40, the breaking separation spring 13 drives the breaking contact 11 to swing around the breaking pivoted shaft 16 through the breaking pivoted arm 17 and the joint contact separation spring 23 drives the joint contact 21 to swing around the joint pivoted shaft 26 through the joint pivoted shaft 27, the remaining technical features are the same as the first embodiment of the present invention and will not be repeated here.

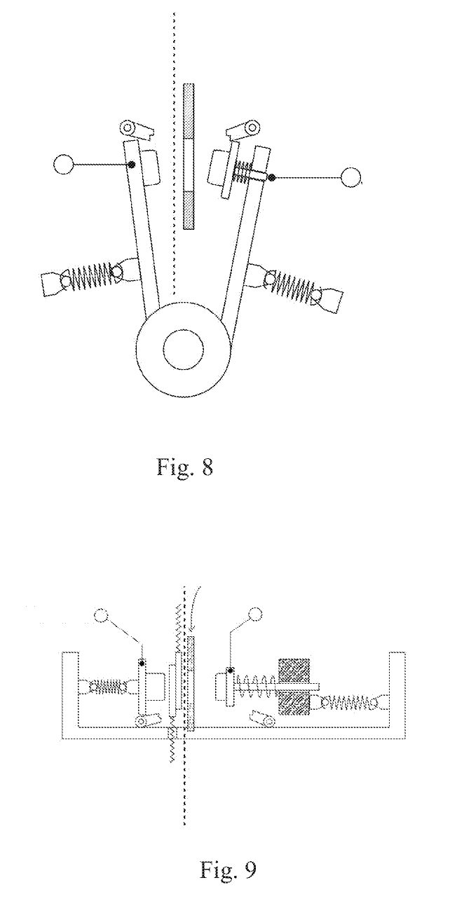

As shown in FIGS. 3 and 8, in the third embodiment of the present invention, the circuit breaker further includes a central pivoted shaft 50; the breaking contact group 10 further includes a breaking pivoted arm 17, and the breaking separation spring 13 drives the breaking contact 11 to swing around the central pivoted shaft 50 through the breaking pivoted arm 17; and, the joint contact group 20 further includes a joint pivoted arm 27, and the joint contact separation spring 23 drives the joint contact 21 to swing around the central pivoted shaft 50 through the joint pivoted arm 27. The joint contact group 20 further includes a contact compression spring 25, and the joint contact 21 is connected to one end of the joint contact separation spring 23 through the contact compression spring 25 and the joint pivoted arm 27. The working process is similar to that of the first embodiment of the present invention and will not be repeated here.

As shown in FIG. 4 or FIG. 9, in the fourth embodiment of the present invention, the circuit breaker further includes one or more insulating plates 61. When the breaking contact 11 is separated from the joint contact 21, the insulating plates 61 are inserted between the breaking contact 11 and the joint contact 21, and the insulating plates 61 are connected to an insulating plate spring 62 for providing to the insulating plates 61 a driving force for insertion. In the present invention, the insulating plate 61 structure is additionally arranged between the breaking contact 11 and the joint contact 21, so better insulating and arc extinction effects are realized while quickening the opening speed of the circuit breaker.

As shown in FIG. 5, in the fifth embodiment of the present invention, the contact limiting device is a toothed lock catch structure. The toothed lock catch structure includes a toothed structure 33 fixedly connected to the joint contact 21 and a limiting lock catch 34 fitted with the toothed structure 33. The limiting lock catch 34 is connected to a limiting spring 35 for providing a pressure to the limiting lock catch 34. Both the limiting lock catch 34 and the limiting spring 35 are arranged inside the joint contact thrust plate 24, and follow and limit the movement of the joint contact thrust plate 24. The design of the toothed lock catch structure allows the limiting lock catch 34 to effectuate unidirectional movement toward the breaking contact relative to the toothed structure 33 under the pressure of the limiting spring 35.

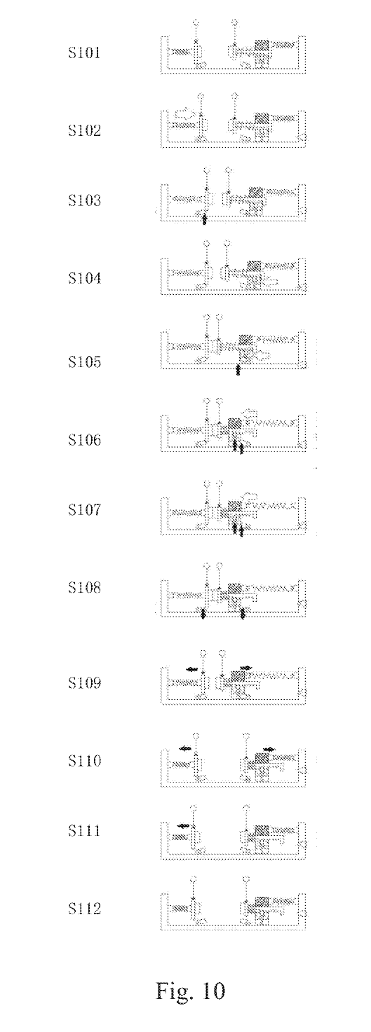

The closing process and the breaking and opening process of the fifth embodiment of the present invention will be described below in details with reference to FIG. 10.

Closing Process:

Steps S501 to S503 correspond to steps S101 to S103 in the first embodiment and will not be repeated here.

S504: The joint contact thrust plate 24 of the joint contact group 20 is pushed to compress the contact compression spring 25, so that the joint contact 21 is allowed to move toward the breaking contact 11; the joint contact separation spring 23 is stressed and extended; and the limiting lock catch 34 follows the joint contact thrust plate 24 to move toward the breaking contact 11.

S505: The joint contact thrust plate 24 is continuously pushed so that the joint contact 21 comes into contact with the breaking contact 11.

S506: The joint contact thrust plate 24 is continuously pushed, and the contact compression spring 25 is stressed and compressed, so that the contact of the joint contact 21 with the breaking contact 11 is pressurized until the joint contact thrust plate 24 is locked by the lock catch and the limiting lock catch 34 and the toothed structure 33 are buckled and locked with each other. Thus, the closing process is finished.

Opening Process:

S507: The breaking contact lock catch 12 and the joint contact lock catch 22 are released, respectively (it is to be noted that, the breaking contact lock catch 12 and the joint contact lock catch 22 can be released simultaneously or successively. In this embodiment, the description is illustrated only by taking simultaneously releasing the breaking contact lock catch and the joint contact lock catch as example. Successively releasing the breaking contact lock catch and the joint contact lock catch is similar to this embodiment and will be not repeated here).

S509: The breaking contact 11 is immediately moved backward and separated from the joint contact 21 by the tension of the breaking separation spring 13; the joint contact thrust plate 24 is moved backward by the tension of the joint contact separation spring 23; and, the limiting lock catch 34 is buckled with the toothed structure 33 so as to allow the joint contact 21 to move backward.

S510: The breaking contact 11 is continuously pulled by the breaking separation spring 13 so as to be separated from the joint contact 21, the joint contact thrust plate 24 is continuously pulled to move backward by the joint contact separation spring 23, and the joint contact 21 continues to move backward.

S511: The joint contact thrust plate 24 is continuously pulled by the joint contact separation spring 23, so that the joint contact 21 is continuously away from the breaking contact 11.

S512: The breaking process is finished. The breaking contact 11 is separated from the joint contact 21, both the breaking contact lock catch 12 and the joint contact lock catch 22 are in a released state, and the breaking separation spring 13, the joint contact separation spring 23 and the contact compression spring 25 are all in a normal state.

In the quick response and separation method for a circuit breaker provided by the present invention, the breaking contact alone moves in a reverse direction prior to the joint contact and is separated from the joint contact, or the breaking contact and the joint contact both move in a reverse direction at the same time and are separated from each other, so quick separation between the contacts is realized, so that the electric arc phenomenon is avoided or reduced, and the service life of the circuit breaker is prolonged. Further, as the breaking contact can move independently of the joint contact, the circuit can be broken at any time, so that the circuit breaker is safer.

In conclusion, in the present invention, the breaking contact 11 is adopted to replace a fixed contact in the conventional art. When the circuit breaker needs to carry out an opening and breaking operation, quick separation between the contacts is realized due to a two-way separation action between the breaking contact 11 and the joint contact 21, so that the electric arc phenomenon is avoided or reduced, and the service life of the circuit breaker is prolonged. Further, as the breaking contact 11 can move independently of the joint contact 21, the circuit can be broken at any time, so that the circuit breaker is safer. Moreover, the present invention has a simple structure, a low production cost and good economic and social effects.

In addition, in the present invention, an insulating plate structure is additionally arranged between the breaking contact and the joint contact, so better insulating and arc extinction effects are realized while quickening the opening speed of the circuit breaker. The technical problem of insufficient contact pressure is solved by arranging contact compression springs. Meanwhile, different switch structures are provided by a pivoted shaft, so that the design of the switch is diversified.

Although the preferred embodiments of the present invention have been specifically described hereinbefore, the present invention is not limited thereto. Those skilled in the art can make various equivalent transformations or replacements without departing from the spirit of the present invention, and all of the equivalent transformations or replacements shall fall into the scope defined by the claims of the present application.

What is claimed is:

1. A circuit breaker with quick response and separation, comprising a breaking contact group including a movable breaking contact and a joint contact group including a movable joint contact, wherein:
a movable contact limiting device used for limiting moving positions of the breaking contact and/or the joint contact is arranged between the breaking contact group and the joint contact group; and
once a breaking operation is triggered, the breaking contact moves in a reverse direction prior to the joint contact to separate from the joint contact, or the breaking contact and the joint contact both move in a reverse direction to separate from each other at the same time.

2. The circuit breaker with quick response and separation according to claim 1, wherein:
the breaking contact group further comprises a breaking contact lock catch for fixing the position of the breaking contact and a breaking separation spring for providing a separation tension for the breaking contact, one end of the breaking separation spring being fixed while the other end thereof being connected to the breaking contact;
the joint contact group further comprises a joint contact lock catch for fixing the position of the joint contact and a joint contact separation spring for providing a separation tension for the joint contact, one end of the joint contact separation spring being fixed while the other end thereof is connected to the joint contact; and
once a breaking operation is triggered, the breaking contact lock catch and the joint contact lock catch are released, respectively, so that the breaking contact and the joint contact are separated under the tension of the breaking separation spring and the tension of the joint contact separation spring, respectively.

3. The circuit breaker with quick response and separation according to claim 1, wherein the extension and contraction of the breaking separation spring and the extension and contraction of the joint contact spring drive the breaking contact and the joint contact to move in a same straight line direction, respectively.

4. The circuit breaker with quick response and separation according to claim 3, wherein the joint contact group further comprises a joint contact thrust plate and a contact compression spring, and the joint contact is connected to one end of the joint contact separation spring successively through the contact compression spring and the joint contact thrust plate.

5. The circuit breaker with quick response and separation according to claim 1, wherein:
the breaking contact group further comprises a breaking pivoted shaft and a breaking pivoted arm, and the breaking separation spring drives the breaking contact to swing around the breaking pivoted shaft through the breaking pivoted arm; and
the joint contact group further comprises a joint pivoted shaft and a joint pivoted arm, and the joint contact separation spring drives the joint contact to swing around the joint pivoted shaft through the joint pivoted arm.

6. The circuit breaker with quick response and separation according to claim 5, wherein the joint contact group further comprises a joint contact thrust plate and a contact compression spring, and the joint contact is connected to one end of the joint contact separation spring successively through the contact compression spring, the joint contact thrust plate and the joint pivoted arm.

7. The circuit breaker with quick response and separation according to claim 1, wherein:
the circuit breaker further comprises a central pivoted shaft;
the breaking contact group further comprises a breaking pivoted arm, and the breaking separation spring drives the breaking contact to swing around the central pivoted shaft through the breaking pivoted arm; and
the joint contact group further comprises a joint pivoted arm, and the joint contact separation spring drives the joint contact to swing around the central pivoted shaft through the joint pivoted arm.

8. The circuit breaker with quick response and separation according to claim 7, wherein the joint contact group further comprises a contact compression spring, and the joint contact is connected to one end of the joint contact separation spring through the contact compression spring and the joint pivoted arm.

9. The circuit breaker with quick response and separation according to claim 1, wherein the circuit breaker further comprises one or more insulating plates; and, once the breaking contact is separated from the joint contact, the insulating plates are inserted between the breaking contact and the joint contact, and the insulating plates are connected to an insulating plate spring for providing to the insulating plates a driving force for insertion.

10. A quick response and separation method for a circuit breaker, comprising a breaking and opening step, wherein:
the breaking contact alone moves in a reverse direction prior to the joint contact to separate from the joint contact, or the breaking contact and the joint contact both move in a reverse direction to separate from each other at the same time and.

11. The quick response and separation method for a circuit breaker according to claim 10, further comprising a closing step, wherein:
the breaking contact moves toward the joint contact and arrives at a contact position prior to the joint contact, and the joint contact moves toward the breaking contact, arrives at the contact position posterior to the breaking contact, and comes into contact with the breaking contact.

12. The quick response and separation method for a circuit breaker according to claim 10, further comprising an opening step during a closing process:
once the joint contact comes into contact with the breaking contact, and if the circuit needs to be broken immediately, the breaking contact is quickly separated from the joint contact in an opposite direction immediately.
